(19) United States
(12) Patent Application Publication
(10) Pub. No.: US 2005/0230355 A1
(43) Pub. Date: Oct. 20, 2005

(54) Method for reducing and controlling hexafluorosilicate concentration during the polishing of glass objects in a polishing bath containing sulphuric acid and hydrofluoric acid

(76) Inventors: Erich Salzle, Munich (DE); Marcus Salzle, Munich (DE)

Correspondence Address: FISH & RICHARDSON, PC, 12390 EL CAMINO REAL, SAN DIEGO, CA, 92130-2081, US

(21) Appl. No.: 10/518,162

(22) PCT Filed: Jun. 18, 2003
(86) PCT No.: PCT/EP03/06487

§ 371 Date: Dec. 14, 2004

(30) Foreign Application Priority Data
Jun. 24, 2002 (DE) 102 28 116.5

(51) Int. Cl. B44C 1/22

(52) U.S. Cl. 216/97

(57) ABSTRACT

The present invention relates to a process for the reduction and control of the concentration of hexafluorosilicate ions formed during the polishing of glass articles in a polishing bath containing sulfuric acid and hydrofluoric acid, wherein potassium fluoride, potassium sulfate, sodium fluoride, sodium sulfate or aluminium sulfate is added to the polishing bath or the sulfuric acid washing bath in a quantity such that a drop in the concentration of fluoride ions below the optimum operating range is avoided.

The present invention relates to a process for the reduction and control of the concentration of hexafluorosilicate ions formed during the polishing of glass articles in a polishing bath containing sulfuric acid and hydrofluoric acid, wherein potassium fluoride, potassium sulfate, sodium fluoride, sodium sulfate or aluminium sulfate is added to the polishing bath or the sulfuric acid washing bath in a quantity such that a drop in the concentration of fluoride ions below the optimum operating range is avoided.

It is known to polish glass articles by chemical means, using a polishing bath containing sulfuric acid and hydrofluoric acid. As a result of the reaction with the glass components occurring during acid polishing, a layer of salt forms on the surface of the glass, substantially consisting of sulfates, fluorides and silicon fluorides of the cations contained in the glasses. This layer of salt then has to be removed by a washing process so that it does not interfere with the rest of the polishing process.

The glasses are conventionally immersed in an acid polishing bath containing approx. 45-60% sulfuric acid and 2.5-5% hydrofluoric acid, and the layer of salt forming on the surface is then washed off the ground surfaces and the plain surface of the glass in a water bath, or preferably in a sulfuric acid washing bath.

Since the ground surfaces, for example, are generally very rough at the beginning of a polishing process, very short immersion periods in the polishing bath, in the range of e.g. 5-15 seconds, have to be selected initially, which can be extended after each immersion operation with subsequent washing off of the layer of salt.

Thus, a large number of alternating treatments in the polishing bath and the washing bath are needed for a complete polishing operation of glass articles, which affects the efficiency of the process. The economic efficiency of these polishing processes is also burdened by high acid consumption, especially of hydrofluoric acid, as well as by a low rate of removal, i.e. long polishing times, and a short operating capability of the polishing bath before the polishing bath has to be renewed or regenerated.

From EP 0 106 301 it is known to add non-oxidising acids, such as e.g. tartaric acid, representing stronger acids than hydrofluoric acid, to the polishing bath to increase the efficiency of the polishing process. This takes place particularly in that the concentration of fluoride ions and optionally sulfate ions in the polishing bath is kept low by inhibited dissociation of the corresponding acids. The dissociation of the hydrofluoric acid can be reduced to such an extent, while maintaining the HF concentration, that the possible residence time of the glass in the polishing bath can be doubled to trebled. If, for example, instead of tartaric acid, oxalic acid is selected to control the HF ion concentration, not only is the concentration of HF ions controlled but also the concentration of sulfate ions, since the dissociation constant of oxalic acid is higher than that of the second stage of sulfuric acid. The scope for the use of oxalic acid is limited by this fact in the polishing of various glass compositions. The use of, for example, phosphoric acid and other more strongly dissociated acids than hydrofluoric acid was not possible owing to the difficult and time-consuming analytical detection.

During the polishing process, considerable quantities of silicon tetrafluoride (SiF₄) are formed by the dissolving of the glass surface, which is initially dissolved in the polishing bath as hexafluorosilicic acid (H₂SiF₆) by the hydrofluoric acid present in excess and is precipitated to a minor degree as potassium hexafluorosilicate (K₂SiF₆) or sodium hexafluorosilicate (Na₂SiF₆) by the during the simultaneous conversion of the alkalis contained in the glass (potassium 7-13% and sodium 3-5%).

The excess silicon tetrafluoride removes hydrofluoric acid from the polishing bath with the formation of hexafluorosilicic acid and is dissolved in both the polishing bath and the washing bath, becoming concentrated in the baths in the course of several polishing cycles. Since hexafluorosilicic acid is more strongly dissociated than hydrofluoric acid, the proportion of fluoride ions is forced down during prolonged use of the baths to such an extent that a homogeneous attack on the glass surface no longer takes place. Since the proportion of hydrofluoric acid can no longer be increased, the rate of polishing decreases considerably in the course of a shift.

Since increasing numbers of zinc-containing lead crystal glasses have been produced in recent years, a further marked reduction in the rate of polishing has been observed. With the proportion of zinc dissolved in the bath, the proportion of hexafluorosilicate ions grows at the same time, since zinc hexafluorosilicate is very highly soluble in the baths. This leads to a reduction in the proportion of fluoride ions and thus also in the polishing rate.

The concentrating of the hexafluorosilicate ion is heavily dependent on, among other things, the proportion of the surface in relation to the polishing bath volume, the exhaust rate and the reduced pressure over the polishing bath and washing bath surfaces.

After an operating period of about eight hours, the polishing operation according to the prior art generally has to be interrupted because of the strong concentration of salts and hexafluorosilicate, so that the potassium and/or sodium hexafluorosilicate not yet precipitated at the polishing bath temperature is separated out after cooling.

The object of the present invention is therefore to provide a process for the reduction and control of the hexafluorosilicic acid concentration during the polishing of glass articles in a polishing bath containing sulfuric acid and hydrofluoric acid, which exhibits a high rate of removal while the operating capability of the polishing bath is extended. A further object of the present invention lies in increasing the efficiency of the polishing bath and the sulfuric acid washing bath while the consumption of sulfuric acid and hydrofluoric acid and special cleaning measures are to be kept as low as possible. In particular, the process according to the invention should also be suitable for the polishing of glasses containing zinc or magnesium.

The object is achieved according to the invention in that potassium or sodium fluoride and/or potassium or sodium sulfate or aluminium sulfate is added to the polishing bath and/or the sulfuric acid washing bath. By adding these salts, the hexafluorosilicic acid and zinc hexafluorosilicate formed during the polishing process are precipitated or the concentration thereof is kept constant by targeted precipitation.

The present invention is based on the finding that the dissolved hexafluorosilicic acid becoming concentrated in an uncontrolled manner and the dissolved zinc hexafluorosilicate represent the reason for the uncontrolled reduction in the dissociation of the hydrofluoric acid, and thus also for the failure to stay within the optimum concentration range, in which there is no longer any solubility of the fluorides that form. This becomes apparent in a reduction in the rate of reaction in the course of the process. The concentrating of hexafluorosilicate during a shift takes place in an uncontrolled manner and can therefore only be countered by continuously extended polishing times and extra additions of hydrofluoric acid per batch until the end of the shift. Up to the present, it was known only that potassium-containing glasses can be polished more easily, and that the polishing process takes approx. 17 minutes with a freshly prepared polishing bath and later, with a fully used polishing bath, all of 45 to 55 minutes. Before zinc found its way into glass compositions, the equilibrium between the evaporation of the silicon tetrafluoride, and thus of the dissolved hexafluorosilicate, could be controlled by means of the spatial design of the polishing plants, the ratio of the bath volume to the surface, the movement of the glasses in the polishing and washing baths, the selected temperature and the quantity of exhaust air, and thus the reduced pressure over the bath surface. In addition, the batch sizes were almost doubled while maintaining the same exhaust performance on the basis of design measures. Since the dissociation of hexafluorosilicic acid is greater than the dissociation of hydrofluoric acid, the proportion of the fluoride ion is reduced as the concentration of hexafluorosilicate ions increases, to such an extent that a homogeneous attack by the fluoride ions, especially on the ground surfaces, is no longer possible. Insoluble salt compounds form, which lead to the destruction of the ground surfaces. Because of the growing proportion of zinc ions, the increasing concentration of hexafluorosilicate ions interferes with the control by tartaric acid of the fluoride ion, and thus of the attack on the glass, and so this control becomes impossible. Substantially two types of polishing machines or polishing plants are used in the industry, namely the closed barrel process and the open rack dipping process. Because of the higher proportion of dissolved hexafluorosilicic acid in the closed barrel machine, it was impossible to control the polishing process with tartaric acid, even without the proportion of zinc in the glass combination.

According to the solution of the invention, hexafluorosilicic acid, which is formed from silicon tetrafluoride, which forms during the polishing process in the polishing bath, and considerable quantities of hydrofluoric acid, is continuously or periodically removed from the solution in that it is precipitated by adding metal fluorides or metal sulfates.

In principle, those metal salts which are only sparingly soluble as metal hexafluorosilicate in the polishing bath and/or in the sulfuric acid washing bath, i.e. which cause precipitation, are suitable for the process of the invention. These include potassium fluoride, potassium sulfate, sodium fluoride, sodium sulfate and aluminium sulfate. Mixtures of different metal salts can also be used. It must be ensured that the concentration of the hexafluorosilicic acid is reduced sufficiently so that the controlling action of the optionally used tartaric acid is not impaired. The process according to the invention can be conducted both in the absence and in the presence of tartaric acid.

The hexafluorosilicic acid that forms during the polishing process is preferably precipitated as potassium hexafluorosilicate by adding potassium fluoride or potassium sulfate.
2KF+H₂SiF₆→K₂SiF₆+2HF
K₂SO₄+H₂SiF₆→K₂SiF₆+H₂SO₄

An advantage of the invention lies in the fact that, by precipitating the hexafluorosilicic acid using potassium fluoride or potassium sulfate, the original state of the polishing bath and/or the sulfuric acid washing bath, i.e. for example as on start-up with a fresh polishing bath, can be permanently maintained. As a result, the efficiency of the baths is considerably improved.

A precipitation of the hexafluorosilicic acid using sodium fluoride, sodium sulfate or aluminium sulfate is somewhat more complicated, as the majority of the hydrofluoric acid needed for the process is co-precipitated if the hexafluorosilicic acid ion is not determined accurately before the precipitation. On the other hand, precipitation with aluminium sulfate has the advantage that the resulting Al₂(SiF₆)₃ is much more insoluble than K₂SiF₆. The sodium ion or potassium ion that forms during the polishing process is also precipitated by the dissolved hexafluorosilicic acid as sodium hexafluorosilicate or as potassium hexafluorosilicate.
2NaF+H₂SiF₆→Na₂SiF₆+2HF

An advantage of the present invention lies in the fact that, in the absence of hexafluorosilicic acid in the polishing bath, the proportion of fluoride in the polishing bath can be substantially smaller and the glass removal can then be better controlled, and thus can be lower with a better surface quality of the glass.

Within the framework of the process according to the invention, 2 to 10 g, preferably 2.5 to 4.5 g, of metal fluoride or 3 to 15 g, preferably 5 to 8 g, of metal sulfate per litre of polishing bath or sulfuric acid washing bath are generally added to the polishing bath or sulfuric acid washing bath for a batch size of between 150 and 500 glasses. According to a preferred embodiment, 2 to 10 g of metal fluoride or 3 to 15 g of metal sulfate, preferably 2 to 5 g of metal fluoride or 5 to 8 g of metal sulfate, particularly preferably 2.5 to 4.5 g of potassium fluoride, per litre of polishing bath are added to a polishing bath containing 45 to 65 wt. % sulfuric acid and 0.8 to 3.6 wt. % hydrofluoric acid. As already stated above, metal fluorides and metal sulfates can also be used simultaneously. The values given for the preferred quantities relate to particular rack sizes, and thus batch sizes (varying between 150 and 500 glasses). A rack of this size holds e.g. about 200 champagne glasses with long stems or about 500 whisky glasses, and requires an acid polishing volume of about 1000 to 1300 l of polishing acid. The person skilled in the art is familiar with conversion to other rack/batch sizes.

Another advantage of the present invention lies in the fact that the number of alternate treatments between polishing bath and washing bath can be substantially reduced with a low hydrofluoric acid content. Thus, on the one hand, the acid consumption can be substantially reduced and, on the other hand, the overall course of the process can be markedly shortened. The number of alternate treatments after the pre-programme (three special alternations) can be reduced from 6 to 8 alternations to 1 to 4 alternations.

Another advantage lies in the fact that the hydrofluoric acid concentration can be decreased from 3-5% to 1-3% for most glass compositions in the polishing bath. In addition, owing to the lower concentration of hydrofluoric acid, the evaporation of the hydrofluoric acid is considerably reduced and thus the acid consumption is again further reduced.

A further advantage of the process according to the invention lies in the fact that, owing to the better control of the hydrofluoric acid attack in the absence of interfering hexafluorosilicate ions, the polishing of the ground surfaces can be achieved more rapidly, and that the overall glass removal can thus be decreased from approx. 5-6% to 3-5% with a better surface quality. By using the process according to the invention, optimum polishing results can be achieved efficiently and cheaply.

Because of the advantages described above, the total acid consumption is decreased by approx. 20-25% and the polishing process shortened by approx. 30-50%. If the precipitation of the hexafluorosilicate ion is undertaken during the polishing process, potassium hexafluorosilicate is formed together with the insoluble lead sulfate and these have to be removed and disposed of together.

The hexafluorosilicic acid is preferably neutralised with potassium fluoride in the polishing bath and with potassium sulfate in the sulfuric acid washing bath. This provides the advantage that, by using potassium fluoride, more than a third of the hydrofluoric acid needed for the polishing process is introduced via the solid potassium fluoride dissolved in sulfuric acid. This takes place without the sulfuric acid-consuming introduction of 25-30% water into the polishing bath when using 70-75% hydrofluoric acid. Similarly, there is the possibility of introducing the required sulfuric acid into the sulfuric acid washing bath via potassium sulfate or aluminium sulfate with the precipitation.

According to another embodiment, the addition of the metal salts, particularly potassium sulfate or potassium fluoride, can also take place after the polishing process in a resting stage in the working vessel, settling vessel or storage vessel. The working vessel is the reaction vessel for the polishing process or the working vessel for the sulfuric acid washing bath in the polishing plants. In addition to the working vessels in the polishing plants, additional settling vessels are provided in almost all rack dipping and barrel plants for the polishing acid and the sulfuric acid washing bath for the sedimentation of the suspended lead sulfate salts or other insoluble salts and, after cooling, for the precipitation of some of the dissolved salts. If, on completion of the polishing operation, both the polishing bath and the sulfuric acid washing bath are freed from the suspended salts by sedimentation, and the clear solutions are separated from the deposited salts, the neutralisation with potassium fluoride can take place in separate settling vessels and the potassium hexafluorosilicate can be obtained in very pure form and sold to the enamel industry or to the wood preservative industry as a valuable salt. The neutralisation can also take place during the resting phase in the baths or in the settling vessels. For this purpose, air must be blown in for at least 10 minutes after adding the potassium sulfate or the potassium fluoride to terminate the reaction. In addition, the proportion of used acid to be disposed of is greatly reduced by targeted neutralisation. Approx. 50% of the hydrofluoric acid used is conventionally absorbed in the absorbing water in the absorption plant as hexafluorosilicic acid. With KF, the hexafluorosilicic acid can be separated from the hydrofluoric acid. The circulating water contains approx. 15-20% hexafluorosilicic acid and approx. 3-6% HF. If only 85-90% of the hexafluorosilicic acid is neutralised, and no soluble KF is present, the solution can be reused to absorb the silicon tetrafluoride. As a result, the difficult neutralisation of the absorbing water with milk of lime becomes unnecessary, as does the expensive disposal of the pressed lime cake in a special waste tip due to the high fluoride content.

According to a preferred embodiment, the removal of hexafluorosilicic acid can be accelerated by blowing in air, particularly filtered air. By blowing in air, locally generated reduced pressure causes hexafluorosilicic acid to be broken down into silicon tetrafluoride and hydrofluoric acid and removed with the exhaust air. This can take place both during and after the polishing operation.

According to another embodiment, the process according to the invention can contain the additional step of adding oxalic acid. This is particularly suitable for glasses containing zinc or magnesium. In more modern glass compositions, different quantities of zinc are added to improve the melting of the glass and magnesium is added to reduce lead pollution. During the polishing operation, zinc oxide forms readily soluble silicon fluorides and magnesium is precipitated out as insoluble MgF₂. Thus, as the zinc becomes concentrated, the hexafluorosilicate content increases to the same extent. An increasing proportion of dissolved zinc hexafluorosilicate therefore requires higher concentrations of hydrofluoric acid for the polishing process. This means that substantially higher hydrofluoric acid concentrations are required in both the polishing and the sulfuric acid washing bath. The consequence is an approximately 20-30% higher consumption of hydrofluoric acid and an extension of the polishing time by up to 50%. In most cases, therefore, the positive advantages in the melting process had to be abandoned again.

Zinc ions and the corresponding hexafluorosilicate ions are precipitated together by targeted addition of potassium oxalate, and thus removed.
ZnSiF₆+K₂C₂O₄→K₂SiF₆+ZnC₂O₄

Alternatively, if potassium oxalate is unavailable, the zinc ions can be precipitated with oxalic acid and the hexafluorosilicic acid with KF, individually, in which case oxalic acid is only added to precipitate the zinc ions. An excess of oxalic acid should be avoided here because of the resulting known undesirable controlling function in respect of fluoride and sulfate ions. The preferred quantities of oxalic acid to be used can be determined in preliminary tests by addition to the polishing bath until the limit of precipitation is reached. Preferably, 0.05 to 1 g oxalic acid per litre of polishing bath/batch are added to the polishing bath for a batch size of between 150 and 500 glasses. Potassium oxalate (K₂C₂O₄) can also be added.

As a result, glasses with any levels of zinc or magnesium content can be acid-polished without difficulties for the first time. This makes substantial advantages possible in the melting process and during refinishing.

The process according to the invention is explained further on the basis of the following examples, but is not limited to them.

### EXAMPLE 1

### Precipitation/Neutralisation of H₂SiF₆ with Potassium Fluoride or Potassium Sulfate

A glass goblet weighs on average between 300 and 400 g. During the polishing process, the glass removal is on average between 5 and 6%. In the case of glasses weighing 300 g, the glass removal is therefore between 15 and 18 g/glass and for glasses weighing 400 g it is 20 to 25 g/glass. With an average load of approx. 200 glasses per batch, therefore, between 3000 and 4800 g glass per batch of 200 glasses are removed. The proportion of SiO₂ in lead crystal glasses is generally between 50 and 55%. This means that approx. 1500 to 2640 g SiO₂ are removed per batch. To dissolve 1500 g of the removed SiO₂, 3000 g HF are needed and for 2640 g of the removed SiO₂, 5280 g HF are needed, which corresponds to an acid consumption of approx. 3.5 l to 7 l HF (75%). This also means that between 3600 and 5900 g H₂SiF₆ per batch are initially formed in the polishing and washing baths together. Since the glass contains an average of 12% alkalis, either in the form of potassium oxide or in the form of a mixture of 7 to 8% potassium and 4 to 5% sodium, corresponding proportions of potassium or sodium are released, which precipitate some of the hexafluorosilicic acid that is released. This means, therefore, that if between 3000 and 4800 g glass are removed per batch in an average load of approx. 200 glasses, then 360 to 570 g K₂O are also removed, which lead to the precipitation of H₂SiF₆. The potassium released during the polishing reaction precipitates e.g. 550 to 870 g of the H₂SiF₆ dissolved in the baths.

For a batch of approx. 200 glasses, for example, with a glass removal of 5 to 6%, approx. 3050 g to 5030 g H₂SiF₆ are formed in the polishing bath and washing bath together, which can be precipitated by potassium fluoride or potassium sulfate to obtain an original polishing or sulfuric acid washing bath again. To precipitate 3050 g and 5030 g H₂SiF₆ respectively with K₂SO₄, 3685 g and 6078 g K₂SO₄ respectively are required, with the release of 2075 g and 3432 g H₂SO₄ respectively. To precipitate 3050 g and 5030 g H₂SiF₆ respectively with KF, 2457 g and 4052 g KF respectively are required, with the release of 847 g HF and 1400 g HF respectively, which corresponds to the addition of about 1 to 2 litres of 70% hydrofluoric acid.

During precipitation with potassium fluoride, therefore, the consumption of hydrofluoric acid is reduced by 1 to 2 litres.

Since approx. 50% of the silicon tetrafluoride escapes by evaporation into the absorption plants for the exhaust air, approx. 1.2 to 2 kg KF are needed for the neutralisation of the hexafluorosilicic acid.

### EXAMPLE 2

### Precipitation/Neutralisation of H₂SiF₆ with Aluminium Sulfate

The precipitation of the H₂SiF₆ can also take place with Al₂ (SO₄). Since the solubility of Al₂SiF₆ is substantially lower than that of K₂SiF₆, precipitation with Al₂(SiF₆)₃ would be preferable. However, since the solubility of AlF₃ is very low compared with KF, the proportion of H₂SiF₆ has to be determined accurately before the precipitation when precipitating with Al₂(SO₄)₃ to avoid co-precipitating the free HF, which is needed for the polishing. While the precipitation of H₂SiF₆ with KF is not as effective, it is, however, problem-free with regard to the co-precipitation of the fluoride.

### EXAMPLE 3

### Precipitation of Zinc with Oxalic Acid

The proportion of zinc oxide is currently 1.0 to 2.5% in known glass compositions. The glass removal in the polishing operation is, on average, between 5 and 6%. The removal of glass is therefore between 15 and 18 g/glass in the case of glasses weighing 300 g and 20 to 25 g/glass in the case of glasses weighing 400 g. With an average load of approx. 200 glasses per batch, therefore, between 3000 and 4800 g glass per batch of 200 glasses are removed. The proportion of ZnO in lead crystal glasses is generally between 1.0 and 2.5%. This means that approx. 30 to 120 g ZnO are removed per batch. To precipitate 45 g ZnO present in the polishing acid and in the sulfuric acid washing bath as 114 g ZnSiF₆, 0.92 g potassium oxalate (K₂C₂O₂) are needed, and to precipitate 120 g ZnO, which is present as 305 g ZnSiF₆, 245 g potassium oxalate are needed. Should potassium oxalate be unavailable, the precipitation of 45 g ZnO can also take place with approx. 50 g oxalic acid (or with 133 g oxalic acid for 120 g ZnO). The corresponding proportion of silicon fluoride can be precipitated separately with KF. For the precipitation of 45 g ZnO, approx. 50 g oxalic acid and for the precipitation of 120 g ZnO, 133 g oxalic acid have to be added to the baths. Since the proportion of zinc oxide is relatively small, the markedly increasing stabilisation of the hexafluorosilicate ion only becomes noticeable after prolonged use of the baths. With regular precipitation of the zinc by adding appropriate quantities of oxalic acid, the H₂SiF₆ concentrations both in the polishing bath and in the sulfuric acid washing bath remain stable and the polishing rate is no longer reduced by the zinc content in the glass. Also, owing to the precipitation of zinc, weakness due to pimple formation on the unground glass surface is avoided. The SiF₄ and HF evaporating into the absorption plants is absorbed there as H₂SiF₆ and can be pumped off after reaching the permitted concentration of 15-20%, and the H₂SiF₆ precipitated separately there with KF and thus separated from the free HF. The HF liberated can be reused for the absorption of the SiF₄.

1-9. (canceled)

10. A process for the reduction and control of the hexafluorosilicate concentration during the polishing of glass articles in a polishing bath containing sulfuric acid and hydrofluoric acid, wherein during and/or after the polishing operation, potassium fluoride, potassium sulfate, sodium fluoride, sodium sulfate and/or aluminium sulfate is added to the polishing bath and/or the sulfuric acid washing bath in quantities of 2-10 g of the metal fluoride or 3-15 g of the metal sulfate per liter of polishing bath or sulfuric acid washing bath for a batch size of between 150 and 500 glasses so that a reduction in the concentration of fluoride ions below an optimum operating range is avoided.

11. A process according to claim 10, wherein when potassium sulfate, sodium sulfate or aluminium sulfate is added, zinc ions present in the polishing bath and/or in the sulfuric acid washing bath are, for the most part, co-precipitated as zinc sulfate.

12. A process according to claim 10, wherein at least one of the group comprising: potassium fluoride, K₂SO₄, Na₂SO₄, and NaF, is added to the polishing bath.

13. A process according to claim 10, wherein potassium sulfate and/or aluminium sulfate is added to the sulfuric acid washing bath.

14. A process according to claim 10, wherein after the polishing operation, the addition of a metal fluoride and/or a metal sulfate is performed in a working vessel, settling vessel or storage vessel.

15. A process according to claim 10, wherein preferably filtered air, is additionally blown into the polishing bath and/or the sulfuric acid washing bath.

16. A process according to claim 10 wherein oxalic acid and/or potassium oxalate is additionally added to the polishing bath, preferably 0.05 to 1 g per liter polishing bath/batch for a batch size of between 150 and 500 glasses.

17. A process according to claim 10, wherein 2.5 to 4.5 g of the metal fluoride or 5 to 8 g of the metal sulfate per liter of polishing bath or sulfuric acid washing bath are added to the polishing bath or the sulfuric acid washing bath for a batch size of between 150 and 500 glasses.

18. A process according to claim 17, wherein 2 to 5 g of the metal fluoride or 5 to 8 g of the metal sulfate per liter of polishing bath are added to a polishing bath containing 45 to 65 wt. % sulfuric acid and 0.8 to 3.6 wt. % hydrofluoric acid, preferably 2.5 to 4.5 g potassium fluoride.
